(19) United States
(12) Patent Application Publication
(10) Pub. No.: US 2024/0142374 A1
(43) Pub. Date: May 2, 2024

(54) Gas Flow Chamber Device and Method of ATR Infrared Spectroscopy for Monitoring Chemical Reactions in Controlled Environments

(71) Applicant: Morgan State University, Baltimore, MD (US)

(72) Inventor: Alexandr Samokhvalov, Ellicott City, MD (US)

(21) Appl. No.: 18/498,342

(22) Filed: Oct. 31, 2023

Related U.S. Application Data
(60) Provisional application No. 63/420,975, filed on Oct. 31, 2022.

(51) Int. Cl. G01N 21/552; G01N 21/3504; G01N 21/77; G01N 31/10

(52) U.S. Cl. CPC G01N 21/552; G01N 21/3504; G01N 21/77; G01N 31/10; G01N 2021/3595

(57) ABSTRACT

A gas flow chamber device and method for in-situ time-dependent attenuated total reflectance (ATR) infrared spectroscopy for monitoring solid-gas and liquid-gas chemical reactions in a gaseous flowing medium (gas or vapor) within a controlled environment includes a flow chamber enclosure attached to the infrared spectrometer, such that it covers the specimen on the ATR plate of the infrared spectrometer; a flow chamber inlet port to provide the gaseous flowing medium of desired chemical composition inside the chamber and in contact with the specimen; and a flow chamber outlet port to provide for the exhaust of the gaseous flowing medium from the flow chamber after the gaseous flowing medium has been in contact with the solid or liquid specimen.

### BACKGROUND OF THE INVENTION

### Field of the Invention

The present invention is directed to systems for the monitoring of solid-gas and liquid-gas chemical reactions.

### Related Art

The utility of monitoring the progress of chemical reactions by instrumental analysis is well established. Such monitoring is extensively used in many branches of industry, where the content of a reactor is monitored by its periodic chemical analysis. In petroleum industry, catalytic cracking is used to produce commercial transportation and heating fuels as well as other useful products. The systematic and frequent monitoring of chemical composition of the reactor is essential for its normal operation.

Sometimes, the so-called “ex-situ” analysis is utilized, when a fraction of the solid or liquid of interest is removed from the reactor for instrumental analysis. The “ex-situ” reaction monitoring means that the collected specimen is altered during its transfer from reactor to the analytical instrument and is not returned back to the reactor. One limitation of “ex-situ” monitoring is breaking a mass balance of reactants, products and catalyst. Another major limitation of ex-situ monitoring is that it takes time to transfer the collected specimen from the reactor to the analytical instrument. Therefore, it becomes not possible to determine continuously the progress of reaction as function of time as it occurs (its chemical kinetics).

To mitigate the limitations of ex-situ analysis of the ongoing reaction, the “in-situ” mode of monitoring of a reaction is often utilized. In the in-situ mode, the reactor is essentially made to be a part of measurement instrument, and the spectra (or other characteristics of chemical compounds) are recorded in time as reaction proceeds. This eliminates the need of periodic specimen withdrawal for analysis. In addition, in-situ analysis allows continuous reaction monitoring, which means the determination of identity and amounts of multiple reactants and products when they are formed or consumed.

Infrared (IR) spectroscopic analysis is promising for in-situ reaction monitoring. In the IR spectroscopic analysis, absorbance (or transmittance) of the infrared light passing through the specimen is measured for each wavenumber (cm⁻¹) aka “frequency”. Vibrations of atoms in molecules are detected as wavenumbers of peaks in the infrared spectrum, at the maximum absorbance (or the minimal transmittance). These wavenumbers reflecting energies of vibrations of atoms in the specimen are routinely used to determine molecular structure of compounds. Also, absorbance of the infrared radiation depends on the concentration of the given compound in the specimen, and its quantitative analysis becomes possible.

The attenuated total reflectance aka reflection (ATR) infrared spectroscopy (aka ATR-IR spectroscopy) is routinely used for “ex-situ” analysis of solids and liquids. In the ATR-IR spectroscopy, the beam of the infrared light is first directed into the ATR crystal. The ATR crystal is made of special material, which is transparent in the infrared range and which has high index of refraction. The material of the ATR crystal is often one of the following: diamond, zinc selenide ZnSe, zinc sulfide ZnS, germanium Ge, sapphire, thallium bromoiodide KRS-5, and silver halide AgX. In the ATR crystal, the infrared electromagnetic radiation is confined, so that only its evanescent field escapes the ATR crystal and penetrates the surrounding medium for a few micrometers. When the specimen is placed on top of the ATR crystal and pressed to it to make tight contact, the specimen absorbs a fraction of the evanescent field. The non-absorbed part of the IR radiation is reflected inside the ATR crystal, then it escapes the crystal and is delivered to the detector. The fraction of the absorbed IR light at the specific wavenumbers is represented as the attenuated total reflectance Fourier transform infrared (ATR-FTIR) spectrum, in which the X axis is the set of wavenumbers of the IR radiation and the Y axis is absorbance (or transmittance) of this radiation, at each wavenumber.

The ATR crystal can allow one or more than one internal reflection of the IR light, before it escapes the crystal. If the reflection occurs once, it is a single-bounce (“standard”) ATR-FTIR crystal. In most cases, analysis of solids is conducted by the single-bounce ATR-FTIR spectroscopy. When the reflection occurs several times, this is a multi-bounce ATR crystal, which is usually used with liquid specimens, wherein it is denoted horizontal attenuated total reflectance (HATR) crystal. Few implementations of the ATR-FTIR spectroscopy accessories for in-situ studies of homogeneous reactions have been patented. U.S. Pat. No. 3,240,111, entitled “Attenuated total reflection attachment for spectrophotometers,” was the first to address such reactions. U.S. Pat. No. 9,897,541 describes the attenuated total reflection flow cell which serves, at the same time, as chemical reactor, so the continuous in-situ spectroscopic analysis of the liquid is accomplished. The liquid, which contains chemical compounds undergoing the reaction, circulates within this flow cell, and the infrared spectra of that fluid are measured. U.S. Pat. No. 10,352,770 describes the more sophisticated optical spectroscopy system and method for monitoring liquid phase chemical reactions in-situ by the ATR-FTIR method, using laser beam. Importantly, the above listed patents describe monitoring chemical reactions in homogeneous materials systems, which consist of only “liquid” phase. U.S. Pat. No. 7,956,328 relates to a system, device, and methods for real-time screening of live cells, biomarkers, and chemical signatures, including methods for in-situ screening of live cells and stimuli in real-time.

### SUMMARY OF THE INVENTION

This invention presents two novel devices for in-situ ATR-FTIR spectroscopic analysis of solid-gas and liquid-gas reactions. The in-situ flow chambers of the invention may be attached to the infrared spectrometer on demand, to allow in-situ reaction monitoring by the ATR-FTIR spectroscopy method, and then removed on demand as well. Furthermore, for each embodiment, there is provided a corresponding method for monitoring reactions.

More specifically, the present invention is a gas flow chamber device and method for in-situ time-dependent ATR-IR spectroscopy for monitoring solid-gas and liquid-gas chemical reactions in the gaseous flowing medium (gas or vapor) in the controlled environment. The device includes a flow chamber configured to be attached to an infrared spectrometer, such that it covers the specimen on the ATR plate of the infrared spectrometer, a flow chamber inlet port to provide the gaseous flowing medium of desired chemical composition inside the chamber and in contact with the specimen, and a flow chamber outlet port to provide for the exhaust of the gaseous flowing medium from the flow chamber after the gaseous flowing medium has been in contact with the solid or liquid specimen.

Further, the method of using this gas flow chamber attachment for in-situ time-dependent ATR-IR spectroscopy for monitoring solid-gas and liquid-gas chemical reactions in the gaseous flowing medium, while utilizing the controlled environment, includes the following steps:
a solid or liquid specimen is placed on top of the ATR crystal, which is part of the ATR accessory of the infrared spectrometer, and the flow chamber is attached to the infrared spectrometer, so that the flow chamber fully covers the specimen (alternatively, the flow chamber is first attached to the infrared spectrometer, and then the specimen is subsequently inserted inside the flow chamber and placed on top of the ATR crystal, so that the flow chamber fully covers the specimen);
subsequently, the gaseous flowing medium of desired chemical composition is supplied to the flow chamber through its inlet port, when the specimen is already inside the flow chamber and on the ATR crystal (alternatively, the flow chamber is first supplied with the gaseous flowing medium of desired chemical composition, and the specimen is subsequently inserted inside the flow chamber and placed on the ATR crystal);
the solid or liquid specimen, which is on the ATR crystal and is located inside the flow chamber, interacts with one or more components of the gaseous flowing medium;
the infrared spectra of the solid or liquid sample, which is on the ATR crystal and which interacts with one or more components of the gaseous flowing medium, are recorded as function of the time by the infrared spectrometer, and these spectra change in time hence reflecting one or more than one reaction “solid-gas” or “liquid-gas” between the specimen and one or more components of the gaseous flowing medium, and
the gaseous flowing medium escapes the flow chamber through the outlet.

The chemical composition of the gaseous flowing medium can be changed by the operator or equipment, and the above-described procedure may be repeated as many times as necessary.

Accordingly, there is provided according to the invention a device for in-situ time-dependent ATR-IR spectroscopy for monitoring reactions of solid or liquid specimens in a gaseous flowing medium, configured to be attached to an infrared spectrometer, the device comprising: an enclosure configured to cover a solid or liquid specimen placed on an ATR plate of an infrared spectrometer, a gas flow inlet configured to provide a supply of the gaseous flowing medium to the enclosure and to contact the specimen. The device may optionally include a gas flow outlet configured to provide exhaust of the gaseous flowing medium from the enclosure after the gaseous flowing medium has been in contact with the specimen. The device further includes an infrared spectrometer and an ATR accessory, where the ATR accessory is attached to an open face of the enclosure at the ATR plate. The device may include a sealing component between the enclosure and a panel of the infrared spectrometer and/or ATR accessory to minimize escape of the gaseous flowing medium. The device may include a specimen entrance door to permit entry of the specimen and placement on an ATR crystal for spectroscopic analysis. Alternatively, the device may have no entrance door. According to various embodiments, the device may have a gas flow outlet connected to tubing for directing the gaseous flowing medium away from the device for analysis or disposal or regeneration. Alternatively, the device may have no dedicated gas outlet, and the gaseous flowing medium is allowed to escape the flow chamber freely through any openings. According to various embodiments, the internal volume of the enclosure is more than 5 cubic millimeters, or less than 5 cubic micrometers, or between 5 cubic millimeters and 5 cubic micrometers. The device may be comprised of optically transparent materials, optically non-transparent materials, heat insulating materials, heat conducting materials and/or materials which can be heated to high temperature, such as metallic aluminum or stainless steel, materials which can be cooled to low temperatures, and materials that are chemically resistant for work with the gaseous flowing medium, such as Teflon. The device may include a vacuum pump in communication with an interior of the enclosure and configured to create negative pressure within the enclosure. The device may include instrumentation located within the enclosure for measurement of temperature, pressure, and flow rate of the gaseous flowing material, and/or measurement of chemical composition of the gaseous flowing medium, including humidity (water vapor), oxygen, flammable gases such as total combustibles (TOC), hazardous gases such as hydrogen sulfide (H₂S), chemical warfare agent (CWA) such as vapor of sulfur mustard, Sarin or its derivatives, and others. The device may also include heating and/or cooling elements for raising or lowering a temperature of the specimen. Sensors in the device may be connected wirelessly or via wire to external processing/data collection equipment.

There is further provided according to the invention various methods for in-situ time dependent ATR-IR spectroscopy for monitoring reactions between a solid or liquid specimen with a gaseous flowing medium. According to a first of these methods, the steps include attaching a flow chamber to an infrared spectrometer, the flow chamber comprising an enclosure, a gas inlet and a specimen door, inserting the specimen inside the enclosure through the specimen door and placing the specimen on top of an ATR crystal of the infrared spectrometer, pressing the specimen firmly against the ATR crystal, closing the specimen door, directing the gaseous flowing medium from the inlet port through the flow chamber so that solid or liquid specimen reacts with one or more components of the gaseous flowing medium, recording the infrared spectra of the solid or liquid sample as function of time by the infrared spectrometer, the infrared spectra changing as a result of reactions between the specimen and components of the gaseous flowing medium, and allowing the gaseous flowing medium to escape the enclosure.

According to a second of these methods, the steps include attaching a flow chamber to an infrared spectrometer, the flow chamber comprising an enclosure, a gas inlet and a specimen door, directing the gaseous flowing medium from the inlet port through the flow chamber so that it is filled with the gaseous flowing medium, inserting the specimen inside the enclosure through the specimen door and placing the specimen on top of an ATR crystal of the infrared spectrometer, pressing the specimen firmly against the ATR crystal, and closing the specimen entrance door, all while continuing to supply the gaseous flowing medium through the flow chamber, recording the infrared spectra of the solid or liquid sample as function of time by the infrared spectrometer, the infrared spectra changing as a result of reactions between the specimen and the gaseous flowing medium, and allowing the gaseous flowing medium to escape the enclosure.

According to a third of these methods, the steps include placing the specimen on top of an ATR crystal of an infrared spectrometer and pressing it firmly to the ATR crystal, attaching to the infrared spectrometer a flow chamber, so that the specimen on the ATR crystal is inside the flow chamber, the flow chamber comprising an enclosure and a gas inlet, directing the gaseous flowing medium from the gas inlet into the flow chamber so that the specimen reacts with the gaseous flowing medium, recording the infrared spectra of the sample as function of time by the infrared spectrometer, the infrared spectra changing as a result of reactions between the specimen and components of the gaseous flowing medium, and allowing the gaseous flowing medium to escape the enclosure.

According to any of the foregoing methods, the specimen may be solid or liquid. In the case of a solid specimen, it may be placed on an ATR crystal, the material of the ATR crystal may be transparent in the infrared spectral range and may be selected from one of the following materials including but not limited to: diamond, zinc selenide ZnSe, zinc sulfide ZnS, germanium Ge, sapphire, thallium bromoiodide KRS-5, silver halide (AgX).

In the case of a liquid specimen, it may have low vapor pressure, the liquid specimen may be placed on a HATR crystal, the material of the HATR crystal may be transparent in the infrared spectral range and may be selected from one of the following materials including but not limited to: diamond, zinc selenide ZnSe, zinc sulfide ZnS, germanium Ge, sapphire, thallium bromoiodide KRS-5, silver halide (AgX).

According to any of the foregoing methods, the rate of flow of the gaseous flowing medium is constant, including zero value (no flow), or it can be made to not be constant and is changed by the operator or equipment. The chemical composition of the gaseous flowing medium may be kept constant or it may be changed by the operator or equipment or randomly. The chemical composition of the gaseous flowing medium may be known or not known; it may contain a single chemical compound or more than one chemical compound. The gaseous flowing medium may contain one chemical compound (“a carrier”) that is present in greater amounts than any other chemical compounds (“additives”) in the gaseous flowing medium. Or the gaseous flowing medium may contain compounds none of which are present in significantly greater amounts than any other. The carrier may be inert where the additives react with the specimen. The carrier may be any of air, nitrogen, helium, carbon dioxide or others, or both the carrier and additives may react with the specimen. The specimen may undergo reversible or irreversible reactions with one or more components of the gaseous flowing medium. The specimen may adsorb one or more chemical components of the gaseous flowing medium or it may desorb one or more chemical compound, in the form of a gas or a vapor, to the gaseous flowing medium. The specimen may be a catalyst that catalyzes a reaction of one or more components of the gaseous flowing medium. The specimen may be a photocatalyst which catalyzes a chemical reaction(s) of one or more components of the gaseous flowing medium when illuminated with a predetermined wavelength of light.

According to any of the foregoing methods, simultaneous measurement of concentration of components of the gaseous flowing medium may be carried out before, during and/or after contact with the specimen. The processes of the methods may be continuous.

It should be understood that every combination and sub-combination of element, feature, and step described above and herein is considered to be part of the invention and within the scope of the invention unless explicitly incompatible with one another.

### BRIEF DESCRIPTION OF THE DRAWINGS

FIG. 1 is a perspective view of the ATR flow chamber accessory according to an embodiment of the invention.

FIG. 2 is a top perspective view of an ATR flow chamber accessory according to a second embodiment of the invention, in the shape of a hemi-sphere without no specimen entrance door.

FIG. 3 is a top perspective view of the ATR flow chamber accessory of FIG. 2 attached to the panel of an infrared spectrometer.

FIG. 4 is a chart showing relative humidity of air in the flow chamber as a function of time.

FIG. 5A shows water desorption as spectral band in an in-situ time-dependent ATR-FTIR spectra of ambColMolSiev from 3700 cm⁻¹ to 2900 cm⁻¹.

FIG. 5B shows water desorption as spectral peak in an in-situ time dependent ATR-FTIR spectra of ambColMolSiev from 1800 cm⁻¹ to 1500 cm⁻¹.

FIG. 5C shows water binding sites in an in-situ time dependent ATR-FTIR spectra of ambColMolSiev from 1200 cm⁻¹ to 490 cm⁻¹.

FIG. 6 is a chart showing relative humidity inside a flow chamber according to the invention during pre-purge with dried air.

FIG. 7A shows ATR-FTIR spectra of porphyrin aluminum metal-organic framework in the flow of n-pentane vapor in dried air from 3700 cm⁻¹ to 2800 cm⁻¹.

FIG. 7B shows ATR-FTIR spectra of porphyrin aluminum metal-organic framework in the flow of n-pentane vapor in dried air from 1700 cm⁻¹ to 1150 cm⁻¹.

FIG. 7C shows ATR-FTIR spectra of porphyrin aluminum metal-organic framework in the flow of n-pentane vapor in dried air from 1150 cm⁻¹ to 450 cm⁻¹.

FIG. 8A shows ATR-FTIR spectrum of liquid n-pentane from 3750 cm⁻¹ to 2800 cm⁻¹.

FIG. 8B shows ATR-FTIR spectrum of liquid n-pentane from 1700 cm⁻¹ to 1150 cm⁻¹.

FIG. 8C shows ATR-FTR spectrum of liquid n-pentane from 1150 cm⁻¹ to 450 cm⁻¹.

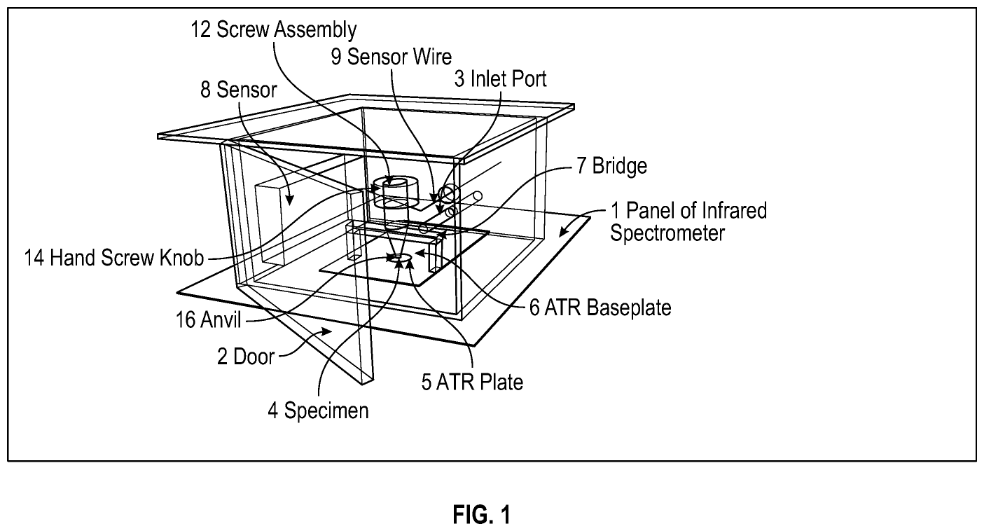

Features in the attached drawings are numbered with the following reference numerals:

| | | | |
|---|---|---|---|
| 1 | panel of the infrared spectrometer; | 2 | door |
| 3 | inlet port | 12 | screw assembly |
| 4 | specimen | 14 | hand screw knob |
| 5 | ATR plate (with ATR crystal) | 16 | anvil |
| 6 | ATR baseplate | 18 | hemi-sphere chamber |
| 7 | bridge | 22 | gas outlet port |
| 8 | sensor | 24 | top hole opening |
| 9 | wiring of the sensor going to the | | |
| | outside of the flow chamber | | |

### DETAILED DESCRIPTION OF THE PREFERRED EMBODIMENT

In a first embodiment, an ATR flow system includes a body in the shape of a box, which has the three walls and one roof, and the specimen entrance door 2 of the box, the gas flow inlet port 3, and the additional equipment (sensor) 8 located inside the flow chamber. The specimen 4 (circle) is placed directly above the ATR crystal (hidden, directly below the specimen). The ATR crystal is embedded into the ATR plate 5 (circle). The ATR plate 5 is embedded into the ATR accessory baseplate 6 (rectangle). The ATR accessory baseplate 6 is configured to be removably attached to the infrared spectrometer. Further, the ATR bridge 7 (part of the ATR accessory) is equipped with a screw assembly 12 (cylinder and cone) which is rotated by the operator to move it up or down, using hand screw knob 14 (cylinder). The screw assembly terminates with an anvil 16 (cone) which, when fully lowered, presses the specimen firmly to the ATR crystal, thus allowing the ATR-FTIR spectroscopic measurement.

The specimen, whether solid or liquid, is fully located inside the flow chamber and pressed to make tight contact with the ATR crystal, is allowed to interact with one or more components of the gaseous flowing medium. As the specimen is reacting with the one or more components of the gaseous flowing medium, the infrared spectra of the specimen are recorded as a function of time by the infrared spectrometer. As the reaction(s) between the sample and the gaseous flowing medium proceed, these spectra change in time, thus reflecting time-dependent progress of one or more reactions “solid-gas” or “liquid-gas” between the specimen and one or more component(s) of the gaseous flowing medium, under both in-situ and time-dependent conditions. The gaseous flowing medium is then allowed to escape the flow chamber through the outlet or other openings. The chemical composition, or physical characteristics, of the gaseous flowing medium, before it enters the flow chamber, can be changed by the operator or equipment, and the procedure repeated.

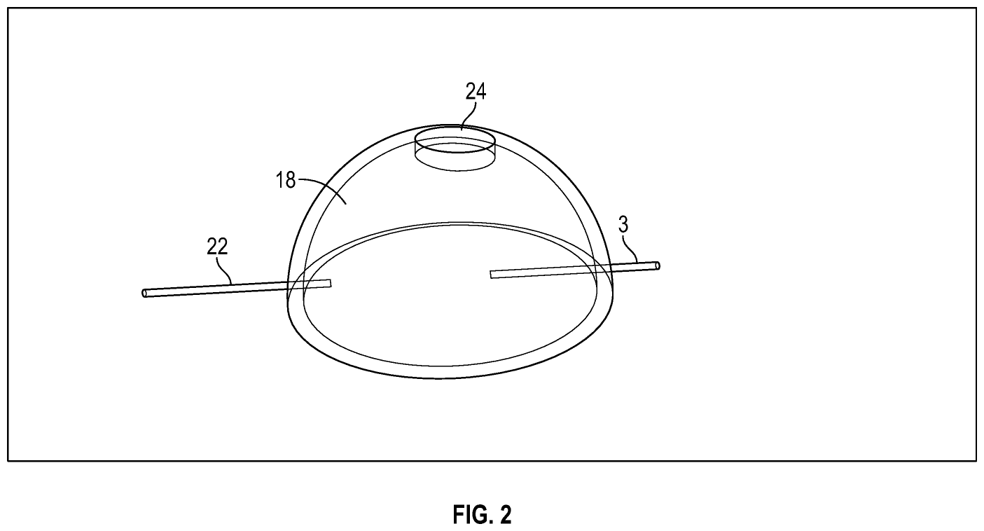

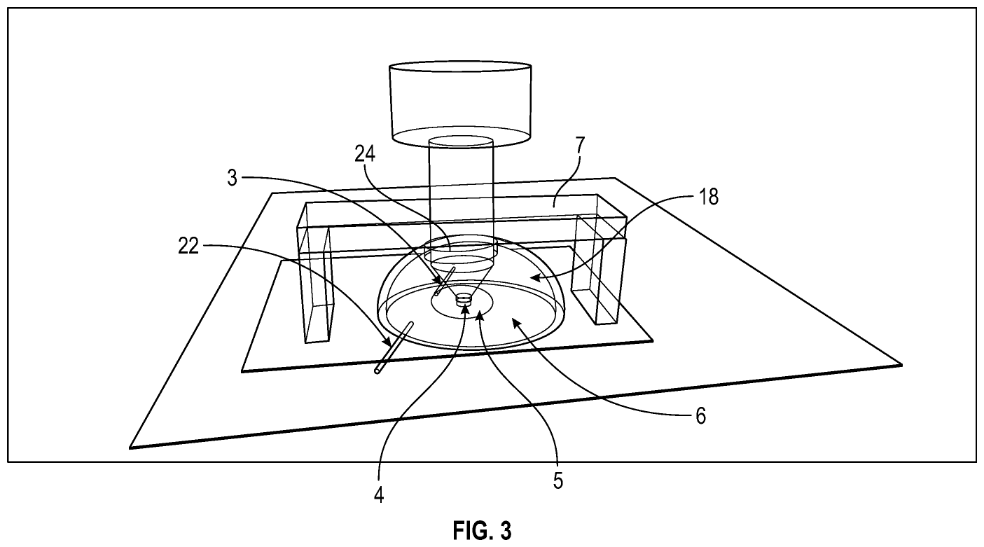

In a second embodiment, shown in FIGS. 2-3, the flow chamber is implemented in the shape of a hemi-sphere, and it does not have a specimen entrance door. It is configured to be reversibly mounted on the ATR baseplate of the ATR accessory of the infrared spectrometer, rather than on the panel of the infrared spectrometer. Also, depending on the actual size of the second embodiment, the described flow chamber can be mounted on the ATR plate of the ATR accessory of the infrared spectrometer.

The flow chamber in the shape of a hemi-sphere 18 has a gas inlet port 3 (a pipe) that protrudes toward the center of the hemi-sphere, where the specimen is to be located. The gaseous flowing medium is supplied to the gas inlet port from external equipment. The flow chamber in the shape of a hemi-sphere also has the dedicated gas outlet port 22 (a pipe on the left) that starts inside the hemi-spherical body of the flow chamber and protrudes outward of the body. The gaseous flowing medium after reacting with the specimen escapes the flow chamber, and it can be either allowed to dissipate in the ambient air or directed to other external equipment for collection and/or additional analysis. The flow chamber in the shape of a hemi-sphere 18 also has a wide center hole 24 on the top, which is intended for the screw assembly of the ATR accessory with the attached anvil. The bridge 7 of the ATR accessory is shown above the flow chamber. The screw assembly (cylinder and cone) protrudes inside the flow chamber via its top opening 24. The ATR baseplate 6 is aligned with the panel of the infrared spectrometer.

### Example 1

In a first test example, monitoring desorption of water vapor from molecular sieves sorbent (which had previously adsorbed water vapor from ambient air) is demonstrated, when conducted in the flow of dried air in the flow chamber and by using in-situ time-dependent ATR-FTIR spectroscopy. The flow chamber has been attached to the top panel of the infrared spectrometer (model Nicolet iS10 from Thermofisher), and this spectrometer had the ATR accessory installed on it (model Golden Gate from SPECAC). The sensor was added to the flow chamber. The sensor was a Temperature and Humidity sensor (Data Logger), model Elitech RC-4HC, with a USB connection. This sensor is able to measure the temperature between −30 and +60° C. and the RH within 0%˜100% every few seconds, using data logging software from Elitech. The USB cable of the sensor was furnished from the inside to the outside of the flow chamber and connected to a lab PC.

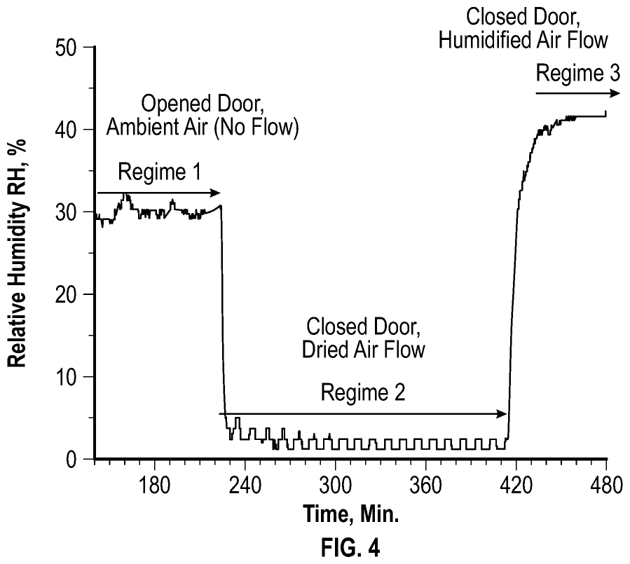

The sorbent was a specimen of color-indicating 4A molecular sieves (from Alfa). The specimen, as received from the vendor, was in the form of beads ca. 2 mm in diameter. In its active form, it had blue color, and such material is denoted asisColMolSiev. The specimen of asisColMolSiev was grinded in an agate mortar and pestle to powder. The powdered specimen of asisColMolSiev was introduced inside the body of the flow chamber through the specimen entrance door, placed on the ATR crystal and pressed tightly with an anvil. The specimen entrance door of the flow chamber was left open for several hours, to allow the specimen to remain in contact with ambient (moderately humid) air at the relative humidity (RH) about 30%, with no flow of gas through the flow chamber. The RH in the flow chamber started to be continuously recorded by the sensor inside the chamber. The temperature was constant at room temperature, while the RH inside the flow chamber is shown (FIG. 4, “Regime 1”) as function of the time. For the time period shown by the Regime 1 arrow (FIG. 4), the RH remained stable at about 30%, which was ambient humidity. Simultaneously, during Regime 1, the in-situ ATR-FTIR spectrum of the specimen of ambColMolSiev on the ATR plate have been recorded, and denoted “ambient” After this procedure, the second type of the specimen was obtained, which became of gray color, contained water adsorbed from ambient air, and was denoted ambColMolSiev.

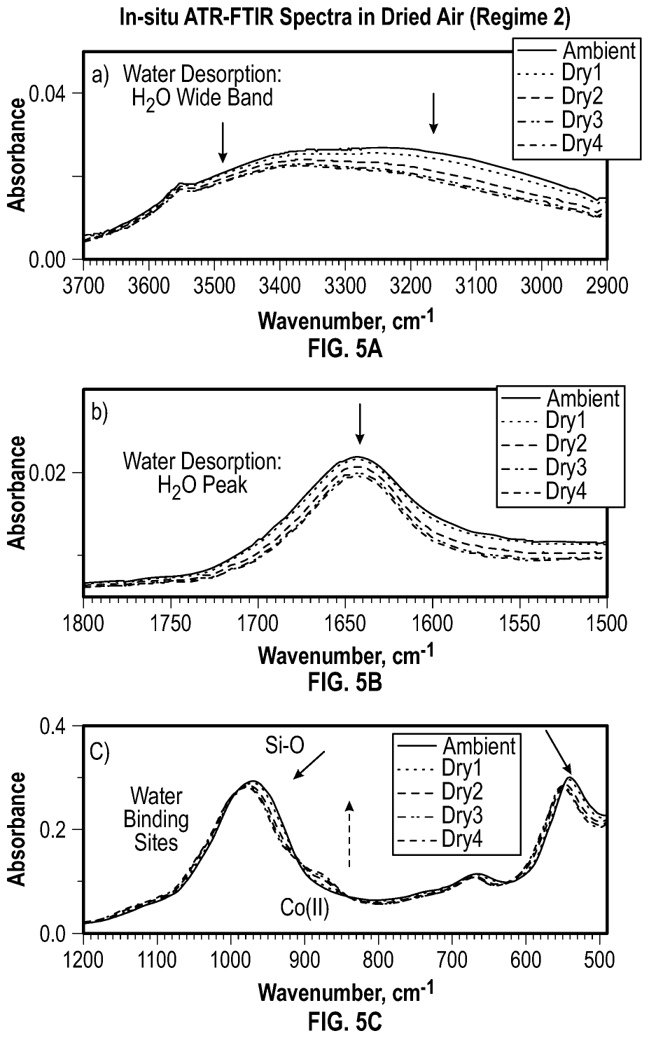

At the time corresponding to the start of Regime 2 (see FIG. 4), the door of the flow chamber was closed, and the chamber started to be purged with the spectroscopically dry air (RH<1%) at the flow rate of 80 standard cubic feet per hour (scfh). The dried air was prepared as follows. The first air compressor was of model California Air Tools 8010A, which supplied compressed ambient air at pressure of 60 psi (pound per square inch), and such compressed ambient air was sent to the FT-IR purge gas generator (Whatman Parker Balston, model 75-52). This first setup produced dried air at the flow rate of 50 scfh. The second air compressor was a single-stage portable electric hot dog air compressor (model 2-Gallon Kobalt QUIET TECH), which supplied compressed ambient air at pressure of 60 psi, and such compressed ambient air was sent to the FT-IR purge gas generator (Whatman Parker Balston, model 75-45). This second setup produced dried air at the flow rate of 30 scfh. The streams of both setups were merged together, to create the total flow of dried air at 80 scfh directed to the flow chamber. At the beginning of Regime 2 (in-situ drying) in the flow of dried air through the flow chamber, the RH inside the flow chamber first sharply decreased to <1% and then remained constant Simultaneously, during Regime 2, the in-situ time-dependent ATR-FTIR spectra of the specimen of ambColMolSiev located on the ATR plate inside the flow chamber have been sequentially recorded in the flow of dried air over the specimen, where the spectra are labeled dry1, dry2, etc. shown in FIG. 5. Spectral resolution was 4 cm⁻¹, and other parameters of the infrared spectrometer were Open Aperture setting and automatic gain; each spectrum was averaged over 512 scans (12.7 min).

Referring to FIG. 5A, one can see gradual disappearance of a wide spectral band at about 3600-3000 cm⁻¹ due to water adsorbate in the sorbent. This band is the overlapped asymmetric and symmetric vibrations of water molecules bonded to 4A zeolite, which forms the crystal lattice of asisColMolSiev sorbent described here. This change indicates gradual loss of adsorbed water from asisColMolSiev sorbent in the stream of dried air, measured by in-situ time-dependent ATR-FTIR spectroscopy, using the described method.

Referring to FIGS. 5B and 5C, one can see a gradual decrease of wide peak at 1700-1600 cm⁻¹, which corresponds to the deformation vibration of water molecules bonded to 4A zeolite in ambColMolSiev sorbent (FIG. 5B). This change confirms gradual loss of adsorbed water from ambColMolSiev sorbent in the stream of dried air. The peak at 985 cm⁻¹ in FIG. 5C is consistent with reported ATR-FTIR spectra of zeolite NaX and color-indicating Zeolite NaX, which was prepared by ion exchange with cobalt (II) nitrate. The water molecules interact with the respective chemical bonds in the sorbent, and progressive shift of this peak indicates the continuing water desorption. The peak shoulder at 890 cm⁻¹ in FIG. 5C corresponds to the color-indicating Co(II) site in the lattice of the sorbent. The progressive increase of this shoulder indicates that the octahedrally coordinated Co(II) sites with coordinated water (of weak pink color) are gradually transformed into the tetrahedral Co(II) sites (of strong blue color), when the sorbent loses water. This data illustrates continuous monitoring the progress of reaction of water desorption:

ColMolSiev[H₂O]ₓ(s)→ColMolSiev[H₂O]_{x-y}(s)+yH₂O(yap) (1)

using the described new method of in-situ time-dependent ATR-FTIR spectroscopy in controlled gaseous environment. The reactant is ambColMolSiev with formula ColMolSiev[H₂O]ₓ. The product is driedColMolSiev which is assigned the formula ColMolSiev[H₂O]_{x-y}. The presented data also illustrate the capability of the described flow chamber to create the controlled, low humidity of the air surrounding the specimen, when the in-situ time-dependent ATR-FTIR spectra are collected.

### Example 2

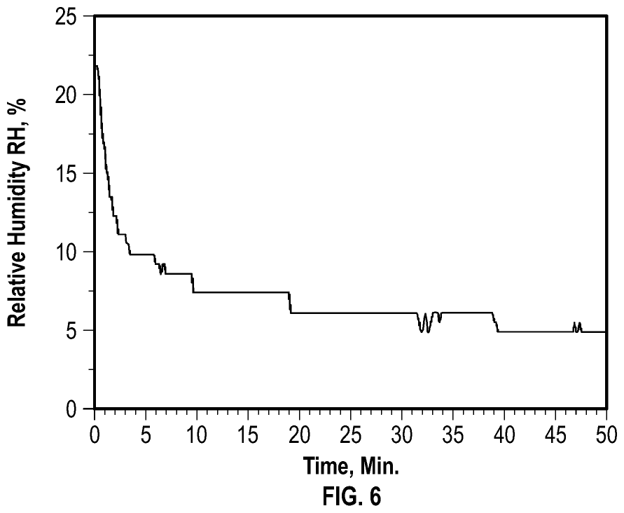

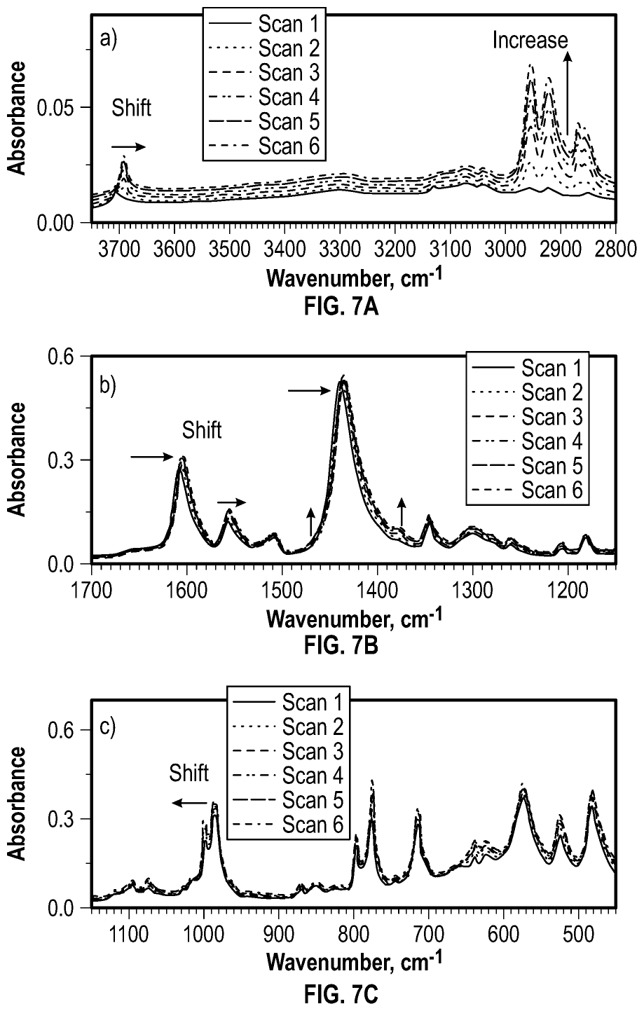

For the second testing example, sorption of vapor of n-pentane in the flow of dried air is monitored, by advanced sorbent coordination polymer metal-organic framework (MOF). This sorbent is porphyrin aluminum metal-organic framework, which contains a linker of tetra-anion of tetrakis(4-carboxyphenyl) porphyrin (TCPPH₂). Herein, this sorbent is denoted compound 2. Preparation of the flow chamber for in-situ time-dependent ATR-FTIR spectroscopy study of sorption of n-pentane vapor by compound 2 at low humidity is as follows. Before the start of vapor sorption experiment, a sample of compound 2 was placed on the ATR crystal, when the flow chamber was attached to FTIR spectrometer, and the door was closed. Dried air was produced by FT-IR Purge Gas Generator (model 74-5041 Parker Balston), which contains a built-in air compressor. This setup allows creating dried air of spectroscopic quality with relative humidity RH<1%. The flow chamber was continuously pre-purged with dried air for over an hour. During pre-purge, the RH inside the chamber was recorded by the sensor in the flow chamber every 10 seconds, see FIG. 6. First, the RH quickly decreased. Then, the RH inside the flow chamber remained low and constant at <5% (the low end of sensor's dynamic range, indicating low humidity ca. 1%). Simultaneously, in-situ ATR-FTIR spectra of specimen of compound 2 on the ATR crystal were recorded, and they did not change during pre-purge with dried air, as expected. Next, the flow of gas through the flow chamber has been switched to reaction gas (dried air saturated with n-pentane vapor). With continuing flow of this reaction gas, in-situ ATR-FTIR spectra were continuously collected; each spectrum takes 1.6 minutes. Upon exposure of compound 2 to vapor of n-pentane in flowing dried air, there are gradual changes in the spectra. First, the peak is recorded at 3708 cm⁻¹ (FIG. 7A) due to the stretch vibration of free O—H group in compound 2, where peak undergoes significant red shift to 3693 cm⁻¹. At the same time, there is no increase of the characteristic peaks of adsorbed water molecules in the range 3600-3200 cm⁻¹. Additionally, in FIG. 7B there is no growth of the characteristic peak at ca. 1650 cm⁻¹ due to deformation vibration of water molecules. This means that the observed spectral shift is due to the interaction of the O—H group in compound 2 with molecules of n-pentane upon its gradual sorption. Second, in FIG. 7A there is significant and progressive growth of new spectral peaks within 3000-2800 cm⁻¹, namely at 2954, 2922, 2869 and 2855 cm⁻¹.

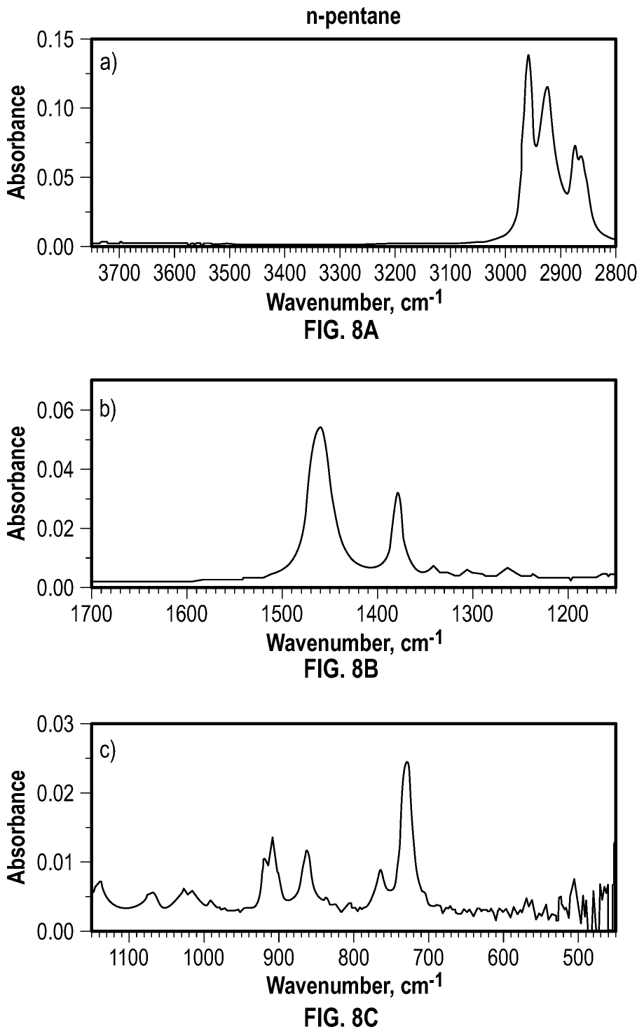

The ATR-FTIR spectrum of liquid n-pentane is similar to what is described above. Namely, four peaks within 3000-2800 cm⁻¹ range (FIG. 8A) belong to asymmetric and symmetric C—H vibrations of CH₃ and CH₂ groups in the n-pentane molecule. Therefore, new peaks at 2954, 2922, 2869 and 2855 cm⁻¹ in FIG. 7A belong to molecules of n-pentane adsorbed by compound 2. Additionally, one can see the peak at 1460 and small peak at 1379 cm⁻¹ marked with arrow (FIG. 7B) which correspond to twist and deformation vibrations of the CH₃ group. They can also be seen in the infrared spectra of compound 2 with adsorbed n-pentane, as weak but growing shoulders (shown by arrows). During the subsequent collection of next six in-situ ATR-FTIR spectra of compound 2 in the flow of n-pentane vapor in dried air (time range 9.7-19.2 min.), there was still some growth of peaks at 2954, 2922, 2869 and 2855 cm⁻¹ (data not shown), but spectral changes stopped by the end of that time interval. This indicates completion of sorption of n-pentane vapor by compound 2 within less than 20 min. During the subsequent purge of the flow chamber with vapor of n-pentane in dried air, the spectra did not change. This means achieving dynamic equilibrium between compound 2 (sorbent) and vapor of n-pentane (adsorbate) in the flow of dried air. This data confirms successful monitoring of the gradual progress of the following reaction:

[Al-MOF-TCPPH₂](s)+x n-C₅H₁₂(yap)→[Al-MOF-TCPPH₂](n-C₅H₁₂)ₓ(s) (2)

using the described new method of in-situ time-dependent ATR-FTIR spectroscopy in a controlled gaseous environment. The product in equation 2 is adsorption complex of compound 2 with n-pentane as “guest” molecules, but this adsorption complex was prepared under dynamic conditions, and its formal stoichiometric index x depends on progress of reaction.

What is claimed is:

1. A device for in-situ time-dependent attenuated total reflectance (ATR) infrared spectroscopy for monitoring reactions between solid or liquid specimens in a gaseous flowing medium, configured to be attached to an infrared spectrometer, the device comprising:
an enclosure configured to cover a solid or liquid specimen placed on an ATR plate of an infrared spectrometer,
a gas flow inlet configured to provide a supply of the gaseous flowing medium to the enclosure and to contact the specimen.

2. The device according to claim 1, further comprising a gas flow outlet configured to provide exhaust of the gaseous flowing medium from the enclosure after the gaseous flowing medium has been in contact with the specimen.

3. The device according to claim 1, further comprising an infrared spectrometer with an ATR accessory, the ATR accessory attached to an open face of the enclosure at an ATR plate of the ATR accessory, wherein the ATR crystal of the ATR accessory can be of a single-bounce type or of the multi-bounce type.

4. The device according to claim 1, wherein the internal volume of the enclosure is less than 5 cubic micrometers.

5. The device according to claim 1, wherein the internal volume of the enclosure is between 5 cubic millimeters and 5 cubic micrometers.

6. The device according to claim 1, wherein the enclosure is comprised of heat insulating material or a heat conducting material.

7. The device according to claim 1, wherein the enclosure is comprised of materials which can be heated to high temperature and/or cooled to low temperatures, such as metallic aluminum or stainless steel, or other materials.

8. The device according to claim 1, further comprising a vacuum pump in communication with an interior of the enclosure and configured to create negative pressure within the enclosure.

9. The device according to claim 1, further comprising instrumentation located within an internal volume of the enclosure configured for measurement of one or more of temperature, pressure, flow rate and chemical composition of the gaseous flowing material.

10. The device according to claim 1, wherein the enclosure contains a heating and/or cooling element for raising or lowering a temperature of the specimen.

11. A method for in-situ time-dependent attenuated total reflectance (ATR) infrared spectroscopy for monitoring reactions between a solid or liquid specimen with a gaseous flowing medium, the method comprising the steps:
attaching a flow chamber to an infrared spectrometer, the flow chamber comprising an enclosure, a gas inlet and a specimen door,
inserting the specimen inside the enclosure through the specimen door and placing the specimen on top of an ATR crystal of the infrared spectrometer,
pressing the specimen firmly against the ATR crystal, closing the specimen door,
directing the gaseous flowing medium from the inlet port through the flow chamber so that solid or liquid specimen reacts with one or more components of the gaseous flowing medium,
recording the infrared spectra of the solid or liquid sample as function of time by the infrared spectrometer, the infrared spectra changing as a result of reactions between the specimen and components of the gaseous flowing medium, and
allowing the gaseous flowing medium to escape the enclosure.

12. A method according to claim 11, comprising
directing the gaseous flowing medium from the inlet port through the flow chamber so that it is filled with the gaseous flowing medium before the specimen is placed in the enclosure.

13. A method for in-situ time-dependent attenuated total reflectance (ATR) infrared spectroscopy for monitoring reactions between a solid or liquid specimen and a gaseous flowing medium, the method comprising the steps:
placing the specimen on top of an ATR crystal of an infrared spectrometer and pressing it firmly to the ATR crystal,
attaching to the infrared spectrometer a flow chamber, so that the specimen on the ATR crystal is inside the flow chamber, the flow chamber comprising an enclosure and a gas inlet,
directing the gaseous flowing medium from the gas inlet into the flow chamber so that specimen reacts with the gaseous flowing medium,
recording the infrared spectra of the sample as function of time by the infrared spectrometer, the infrared spectra changing as a result of reactions between the specimen and components of the gaseous flowing medium, and
allowing the gaseous flowing medium to escape the enclosure.

14. The method according to claim 11, wherein the solid specimen is placed on attenuated total reflectance (ATR) crystal or a horizontal attenuated total reflectance (HATR) crystal, and wherein the material of the crystal is transparent in the infrared spectral range.

15. The method according to claim 11, wherein at least one of the rate of flow of the gaseous flowing medium and the composition of the gaseous flowing medium is not constant.

16. The method according to claim 11, wherein chemical composition of the gaseous flowing medium is not known.

17. The method according to claim 11, wherein the gaseous flowing medium contains more than one chemical compound.

18. The method according to claim 11, wherein at least one component of the gaseous flowing medium compound does not interact with the specimen, and at least one other component of the gaseous flowing medium reacts with the specimen.

19. The method according to claim 11, wherein the specimen adsorbs one or more chemical components of the gaseous flowing medium or desorbs one or more chemical compounds, in the form of a gas or vapor, to the gaseous flowing medium.

20. The method according to claim 11, wherein the specimen is a catalyst that catalyzes or photocatalyzes a reaction with one or more components of the gaseous flowing medium.
